(19) United States
(12) Patent Application Publication
(10) Pub. No.: US 2024/0264588 A1
(43) Pub. Date: Aug. 8, 2024

(54) ARTIFICIAL-INTELLIGENCE-BASED MANUFACTURING

(71) Applicant: NVIDIA CORPORATION, Santa Clara, CA (US)

(72) Inventors: Ron Chao, San Diego, CA (US); Liang-I Lin, Milpitas, CA (US); Tuan Ong, Santa Clara, CA (US); Elad Mentovich, Tel Aviv (IL); Siddha Ganju, Santa Clara, CA (US); Dinesh Krishnaswamy, San Jose, CA (US); Fisher Liu, Shenzhen (CN); Lei Huang, Shenzhen (CN); Nicholas Girard Page, San Jose, CA (US)

(21) Appl. No.: 18/113,217

(22) Filed: Feb. 23, 2023

(30) Foreign Application Priority Data
Feb. 8, 2023 (CN) 202310099546.6

(51) Int. Cl. G05B 19/418

(52) U.S. Cl. CPC G05B 19/41885; G05B 19/41805

(57) ABSTRACT

Methods are described herein for artificial-intelligence-based manufacturing. The present invention may include performing an initial step in a series of steps to achieve a target value of an attribute, where the series of steps is for manufacturing an object, and, after performing the initial step, measuring an actual value of the attribute achieved by the initial step. The method may include, for each subsequent step in the series, providing actual values of attributes achieved by preceding steps in the series to a respective machine learning model to determine a respective target value for a respective attribute to be achieved by the respective step. The method may also include, for each step, performing the respective step to achieve the respective target value of the respective attribute and, after performing the respective step, measuring a respective actual value of the respective attribute achieved by the respective step.

### CROSS-REFERENCE TO RELATED APPLICATION

The present application claims the benefit of Chinese Patent Application No. 202310099546.6 filed Feb. 8, 2023 for “Artificial-Intelligence-Based Manufacturing,” which is hereby incorporated by reference in its entirety.

### FIELD OF THE INVENTION

The present invention relates to methods for manufacturing objects using artificial intelligence.

### BACKGROUND

A manufacturing process for an object may include multiple steps performed in series. Each step may be performed to achieve a predetermined value for an attribute of the object or a component of the object. For example, in a series of steps for manufacturing a vapor chamber, a step may be performed to achieve a predetermined height and/or a predetermined width of an outer shell of the vapor chamber.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, the present invention is directed to a method of manufacturing an object that includes performing a first step to achieve a first target value of a first attribute and, after performing the first step, measuring a first actual value of the first attribute. The method may include providing the first actual value to a first machine learning model to determine a second target value of a second attribute to be achieved by a second step, performing the second step to achieve the second target value of the second attribute, and, after performing the second step, measuring a second actual value of the second attribute. The method may include providing the first actual value and the second actual value to a second machine learning model to determine a third target value of a third attribute to be achieved by a third step and performing the third step to achieve the third target value of the third attribute.

In some embodiments, the first step may have a first manufacturing tolerance, the second step may have a second manufacturing tolerance, and the third step may have a third manufacturing tolerance.

In some embodiments, performing the first step may include performing the first step to achieve the first target value of the first attribute and to achieve a fourth target value of a fourth attribute.

In some embodiments, the method may include training the first machine learning model using first historical data including (i) historical first actual values of first attributes of historical objects and (ii) historical test results obtained by testing the historical objects. Additionally, or alternatively, the method may include training the second machine learning model using second historical data including (i) the historical first actual values of the first attributes of the historical objects, (ii) historical second actual values of second attributes of the historical objects, and (iii) the historical test results.

In some embodiments, the method may include, after performing the third step, performing one or more tests on the object to obtain test results, retraining the first machine learning model using the first actual value and the test results, and retraining the second machine learning model using the first actual value, the second actual value, and the test results.

In some embodiments, the first machine learning model may determine the second target value of the second attribute by running a first plurality of simulations using the first actual value of the first attribute and a second manufacturing tolerance of the second step. Additionally, or alternatively, the second machine learning model may determine the third target value of the third attribute by running a second plurality of simulations using the first actual value of the first attribute, the second actual value of the second attribute, and a third manufacturing tolerance of the third step.

In some embodiments, the object may be a vapor chamber, the first step may include manufacturing an outer shell, the second step may include adding powder to the outer shell to create a porous wicking structure on an interior of the outer shell, and the third step may include adding water to the interior of the outer shell. Additionally, or alternatively, the first attribute may include a height and a width of the outer shell, the second attribute may be an amount-by-weight of the powder, and the third attribute may be an amount-by-weight of the water.

In some embodiments, the object may be a heat pipe, the first step may include manufacturing a tubular outer shell, the second step may include adding powder to the tubular outer shell to create a porous wicking structure on an interior of the tubular outer shell, and the third step may include adding water to the interior of the tubular outer shell. Additionally, or alternatively, the first attribute may include a length and an inner circumference of the tubular outer shell, the second attribute may be an amount-by-weight of the powder, and the third attribute may be an amount-by-weight of the water.

In another aspect, the present invention is directed to a method of manufacturing an object that includes performing an initial step in a series of steps to achieve a target value of an attribute, where the series of steps is for manufacturing an object and, after performing the initial step, measuring an actual value of the attribute achieved by the initial step. The method may include performing subsequent steps in the series to manufacture the object by, for each step, providing actual values of attributes achieved by preceding steps in the series to a respective machine learning model, from a plurality of machine learning models, to determine a respective target value for a respective attribute to be achieved by the respective step, performing the respective step to achieve the respective target value of the respective attribute, and, after performing the respective step, measuring a respective actual value of the respective attribute achieved by the respective step.

In some embodiments, each step in the series of steps has a respective manufacturing tolerance.

In some embodiments, at least one step in the series of steps is intended to achieve multiple target values for respective attributes.

In some embodiments, the plurality of machine learning models may be trained using historical data including (i) historical actual values measured after historical performance of each step of the steps to manufacture historical objects and (ii) historical test results obtained by testing the historical objects.

In some embodiments, the method may include, after performing the series of steps, performing one or more tests on the object to obtain test results and retraining the plurality of machine learning models using data including actual values measured after performance of each step of the series of steps and the test results.

In some embodiments, the plurality of machine learning models may determine respective target values for respective attributes by running a plurality of simulations using (i) the respective actual values of attributes achieved by preceding steps and (ii) manufacturing tolerances of the subsequent steps.

In some embodiments, the plurality of machine learning models may be trained using one or more reinforcement learning algorithms. For example, the plurality of machine learning models may be trained using one or more Q-learning algorithms.

In some embodiments, the plurality of machine learning models may include Siamese neural networks.

In some embodiments, the object may be a vapor chamber, and the series of steps may include a first step of manufacturing an outer shell, a second step of adding powder to the outer shell to create a porous wicking structure on an interior of the outer shell, and a third step of adding water to the interior of the outer shell. Additionally, or alternatively, the first step may be to achieve first respective target values for a height and a width of the outer shell, a second respective target value to be achieved by the second step may be an amount-by-weight of the powder, and a third respective target value to be achieved by the third step may be an amount-by-weight of the water. In some embodiments, the plurality of machine learning models may be trained using historical data including historical heights of outer shells of historical vapor chambers, historical widths of outer shells of the historical vapor chambers, historical amounts-by-weight of powder of the historical vapor chambers, historical amounts-by-weight of water in the historical vapor chambers, historical thermal testing results obtained by thermally testing the historical vapor chambers, and/or the like. In some embodiments, the method may include, after performing the series of steps, performing thermal testing on the vapor chamber to obtain thermal testing results and retraining the plurality of machine learning models using the height of the outer shell, the width of the outer shell, the amount-by-weight of the powder, the amount-by-weight of the water, and the thermal testing results.

In some embodiments, the object may be a heat pipe, and the series of steps may include a first step of manufacturing a tubular outer shell, a second step of adding powder to the tubular outer shell to create a porous wicking structure on an interior of the tubular outer shell, and a third step of adding water to the interior of the tubular outer shell. Additionally, or alternatively, the first step may be to achieve first respective values for a length and an inner circumference of the tubular outer shell, a second respective target value to be achieved by the second step may be an amount-by-weight of the powder, and a third respective target value to be achieved by the third step may be an amount-by-weight of the water. In some embodiments, the plurality of machine learning models may be trained using historical data including historical lengths of tubular outer shells of historical heat pipes, historical inner circumferences of tubular outer shells of the historical heat pipes, historical amounts-by-weight of powder of the historical heat pipes, historical amounts-by-weight of water in the historical heat pipes, historical thermal testing results obtained by thermally testing the historical heat pipes, and/or the like. Additionally, or alternatively, the method may include, after performing the series of steps, performing thermal testing on the heat pipe to obtain thermal testing results and retraining the plurality of machine learning models using the length of the tubular outer shell, the inner circumference of the tubular outer shell, the amount-by-weight of the powder, the amount-by-weight of the water, and the thermal testing results.

In another aspect, the present invention is directed to a system for manufacturing an object. The system may include at least one processing device and at least one non-transitory storage device including computer-executable program code that, when executed by the at least one processing device, causes the at least one processing device to perform an initial step in a series of steps to achieve a target value of an attribute, where the series of steps is for manufacturing an object, and, after performing the initial step, measure an actual value of the attribute achieved by the initial step. The at least one non-transitory storage device may include computer-executable program code that, when executed by the at least one processing device, causes the at least one processing device to perform subsequent steps in the series to manufacture the object by, for each step, providing actual values of attributes achieved by preceding steps in the series to a respective machine learning model, from a plurality of machine learning models, to determine a respective target value for a respective attribute to be achieved by the respective step. The at least one non-transitory storage device may include computer-executable program code that, when executed by the at least one processing device, causes the at least one processing device to perform subsequent steps in the series to manufacture the object by, for each step, performing the respective step to achieve the respective target value of the respective attribute and, after performing the respective step, measuring a respective actual value of the respective attribute achieved by the respective step.

In some embodiments, each step in the series of steps may have a respective manufacturing tolerance.

In some embodiments, the at least one non-transitory storage device may include computer-executable program code that, when executed by the at least one processing device, causes the at least one processing device to train the plurality of machine learning models using historical data including (i) historical actual values measured after historical performance of each step of the steps to manufacture historical objects and (ii) historical test results obtained by testing the historical objects.

In some embodiments, the system may include one or more devices for manufacturing objects, and the at least one non-transitory storage device may include computer-executable program code that, when executed by the at least one processing device, causes the at least one processing device to, when performing the initial step and the subsequent steps in the series, perform the initial step and the subsequent steps in the series using the one or more devices for manufacturing objects.

In some embodiments, the system may include one or more devices for measuring attributes, and the at least one non-transitory storage device may include computer-executable program code that, when executed by the at least one processing device, causes the at least one processing device to, when measuring the actual value of the attribute achieved by the initial step, measure the actual value using the one or more devices for measuring attributes and, when measuring the respective actual value of the respective attribute achieved by the respective step of the subsequent steps, measure the respective actual value using the one or more devices for measuring attributes.

In some embodiments, the system may include one or more devices for testing objects to obtain test results, and the at least one non-transitory storage device may include computer-executable program code that, when executed by the at least one processing device, causes the at least one processing device to, after performing the series of steps, perform one or more tests on the object to obtain test results and retrain the plurality of machine learning models using data including actual values measured after performance of each step of the series of steps and the test results.

The features, functions, and advantages that have been discussed may be achieved independently in various embodiments of the present invention or may be combined with yet other embodiments, further details of which may be seen with reference to the following description and drawings.

### BRIEF DESCRIPTION OF THE DRAWINGS

Having thus described embodiments of the invention in general terms, reference will now be made the accompanying drawings, wherein:

FIG. 1A illustrates an example of a conventional method for manufacturing an object;

FIG. 1B illustrates an example method for manufacturing an object, in accordance with an embodiment of the invention;

FIG. 2A illustrates an example vapor chamber that may be manufactured in accordance with an embodiment of the invention;

FIG. 2B is a diagram depicting functions of an example vapor chamber, in accordance with an embodiment of the invention;

FIG. 2C illustrates an example of a conventional method for manufacturing a vapor chamber;

FIG. 2D illustrates an example method for manufacturing a vapor chamber, in accordance with an embodiment of the invention;

FIG. 2E illustrates an example method for manufacturing multiple vapor chambers, in accordance with an embodiment of the invention;

FIG. 3A illustrates an example heat pipe, in accordance with an embodiment of the invention;

FIG. 3B illustrates a cross-section of the example heat pipe of FIG. 3A, in accordance with an embodiment of the invention;

FIG. 3C is a diagram depicting functions of the example heat pipe of FIG. 3A, in accordance with an embodiment of the invention;

FIG. 3D illustrates an example method for manufacturing multiple heat pipes, in accordance with an embodiment of the invention;

FIG. 4 illustrates an example method for manufacturing an object, in accordance with an embodiment of the invention;

FIG. 5 illustrates an example method for manufacturing an object, in accordance with an embodiment of the invention;

FIG. 6 illustrates a system environment for artificial-intelligence-based manufacturing, in accordance with an embodiment of the invention; and

FIG. 7 is a diagram of example components of one or more devices, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). Like numbers refer to like elements throughout. No element, act, or instruction used herein should be construed as critical or essential unless explicitly described as such.

As noted, a manufacturing process for an object may include multiple steps performed in series. Each step may be performed to achieve a predetermined value for an attribute of the object or a component of the object, and each predetermined value may be selected such that the manufactured object satisfies one or more specifications. However, each step in the series has a manufacturing tolerance such that, even though a step is performed to achieve a predetermined value for an attribute, an actual value of the attribute after performance of the step may not correspond exactly to the predetermined value.

For example, in a series of steps for manufacturing a vapor chamber, a step may be performed to achieve a predetermined height and a predetermined width of an outer shell of the vapor chamber. After performance of the step, an actual height and an actual width of the outer shell will be within a manufacturing tolerance of the predetermined height and the predetermined width but may not have the exact value of the predetermined height and the predetermined width.

Subsequent steps in conventional manufacturing process are performed based on the assumption that previous steps achieved the predetermined values for the attributes of the object. Accordingly, subsequent steps do not account for the manufacturing tolerances that cause deviations between the predetermined values and the actual values. When such deviations accumulate as each step in the series is performed, the manufactured object may not satisfy specifications originally targeted by the selection of the predetermined values. As an example, using conventional manufacturing methods, a manufactured vapor chamber may not dissipate heat as quickly and/or efficiently as originally targeted by selection of the predetermined height and the predetermined width.

Some embodiments described herein provide artificial-intelligence-based manufacturing methods that use machine learning models to adjust target specification values of steps during the manufacturing process. As an example, for a manufacturing process that includes a series of steps, the method includes performing the first step to achieve a target specification value of an attribute and then measuring the actual value of the attribute achieved by the first step. The method includes providing the actual value to a machine learning model to determine a target value for the next step in the series. This process of performing a step in the series, measuring the actual value achieved, and providing the actual value to a machine learning model to determine a target specification value for the next step in the series may be repeated until the series of steps is complete. By using actual, measured values, the method according to embodiments described herein accounts for manufacturing tolerances and/or deviations associated with each step in the process. The machine learning models may be trained using historical data including actual values of attributes of previously manufactured objects, simulation inputs, analytical inputs, and/or historical measurement data of the previously manufactured objects, such that the machine learning models provide target specification values for each step to achieve optimal performance of the object. By using machine learning models to determine target values for each subsequent step in the process, the method improves the performance of the manufactured object as compared to objects made via manufacturing processes that do not account for deviations from the target value due to manufacturing tolerances.

As a simplified example, embodiments of the method may include manufacturing an outer shell of a vapor chamber to have a target height, target length, and a target width and then measuring the actual height, the actual length, and the actual width of the outer shell (e.g., to determine the impact of manufacturing tolerances). The actual height, the actual length, and the actual width may be provided to one or more machine learning models to determine an amount of powder to be used to create a porous wicking structure on an interior of the outer shell. The determined amount of powder may be added to the interior of the outer shell, and the method may include measuring the actual amount of powder added to the interior of the outer shell. The actual amount of powder may be provided to one or more machine learning models to determine an amount of water to be added to the interior of the outer shell in a next step of the manufacturing process. In this way, the target value for each step may be dynamically chosen during the manufacturing process based on the outcome of previous steps to optimize thermal performance of the vapor chamber. Another similar example may include manufacturing a heat pipe, but using machine learning models in this manner during the manufacturing process may be more broadly applied to other manufacturing processes.

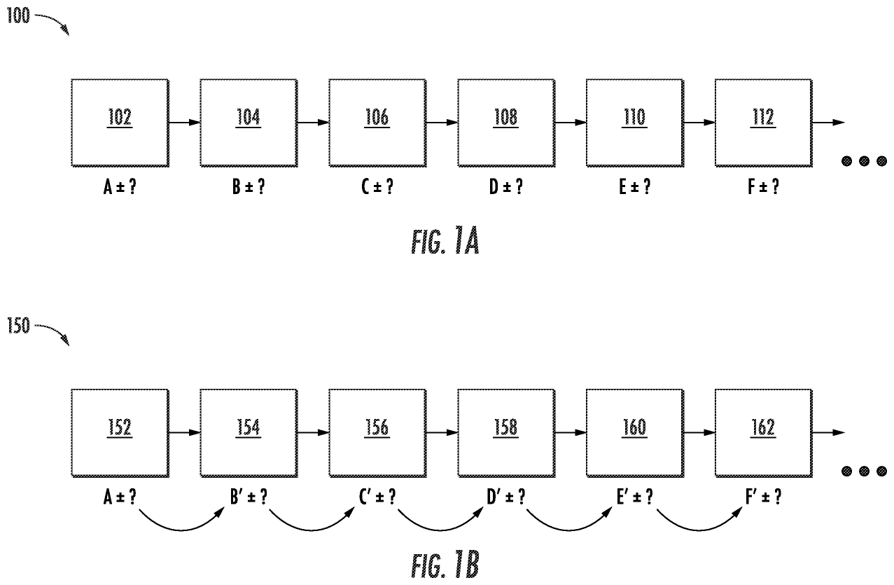

FIG. 1A illustrates an example of a conventional method 100 for manufacturing an object. As shown in FIG. 1A, the method 100 includes steps 102-112, and each of the steps 102-112 is associated with a respective target value A-F. Although only steps 102-112 are shown in FIG. 1A, the method 100 may include additional steps. In the example method 100, each of the steps 102-112 is performed to achieve its respective target value A-F such that the object satisfies one or more specifications.

As also shown by the “±?” in FIG. 1A, each of the steps has a manufacturing tolerance. Thus, even though each of the steps 102-112 is performed to achieve its respective target value A-F, the actual values achieved by the steps 102-112 may deviate from the target values A-F. As noted, such deviations accumulate as each step in the series is performed, and the manufactured object (upon completion of the steps) may not satisfy specifications originally targeted by the selection of the target values A-F and/or provide maximum performance.

FIG. 1B illustrates an example method 150 for manufacturing an object, in accordance with an embodiment of the invention. As shown in FIG. 1B, the method 150 includes steps 152-162. Although only steps 152-162 are shown in FIG. 1B, the method 150 may include additional steps. In some embodiments, the steps 152-162 may respectively correspond to the steps 102-112 of FIG. 1A. For example, and as shown by the “±?” in FIG. 1B, each of the steps may have a manufacturing tolerance. Additionally, the step 152 may have the same target value A as the step 102.

However, in contrast to the method 100 of FIG. 1A, the method 150 of FIG. 1B includes steps 154-162 with respective target values B′-F′, where each of the target values B′-F′ are a function of the actual value achieved by the preceding step. For example, the method 150 may include, after performing the step 152 to achieve the target value A, measuring an attribute of the object to determine an actual value achieved by the step 152, and then determining the target value B′ based on the actual value. In some embodiments, and as described further herein, artificial intelligence may be used to determine optimal values for the target values B′-F′ such that the manufactured object satisfies specifications, provides maximum performance, and/or the like.

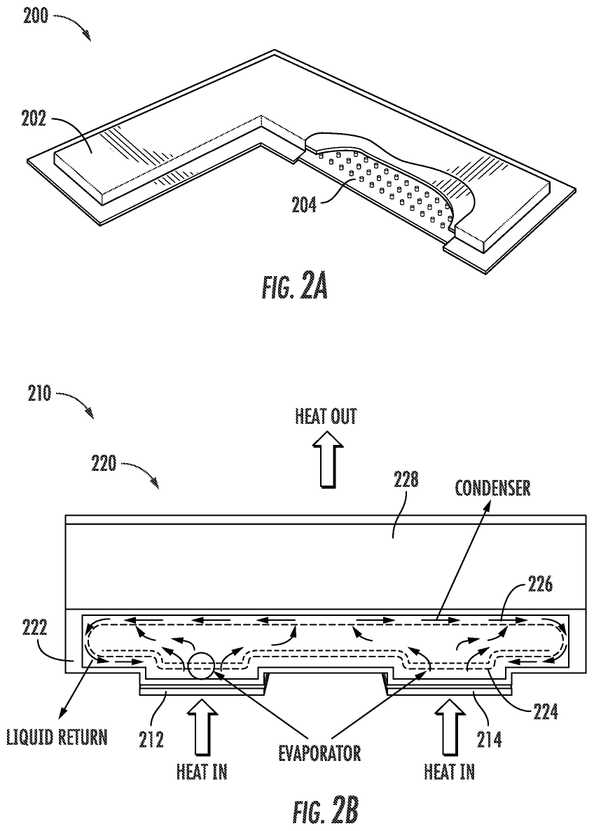

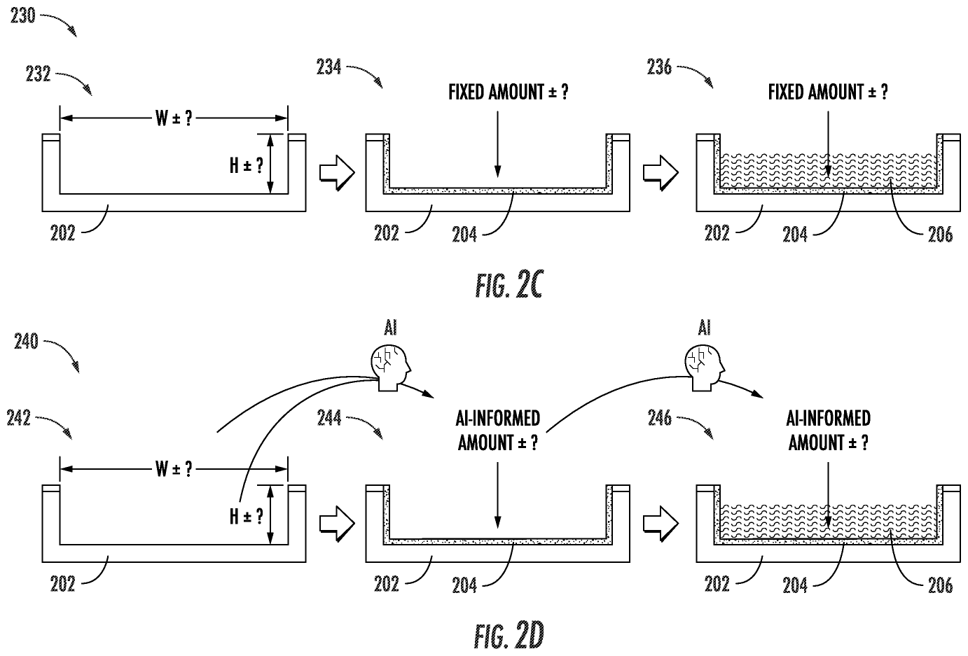

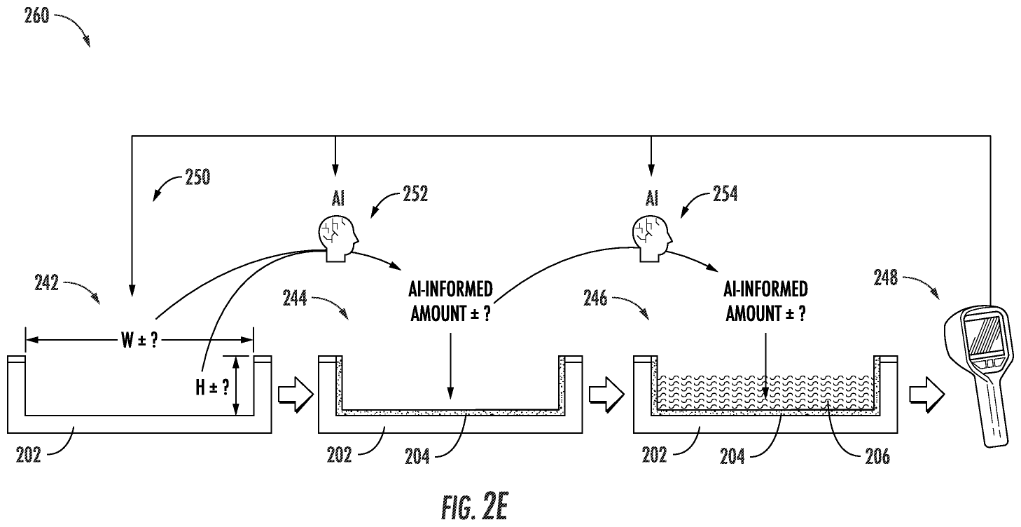

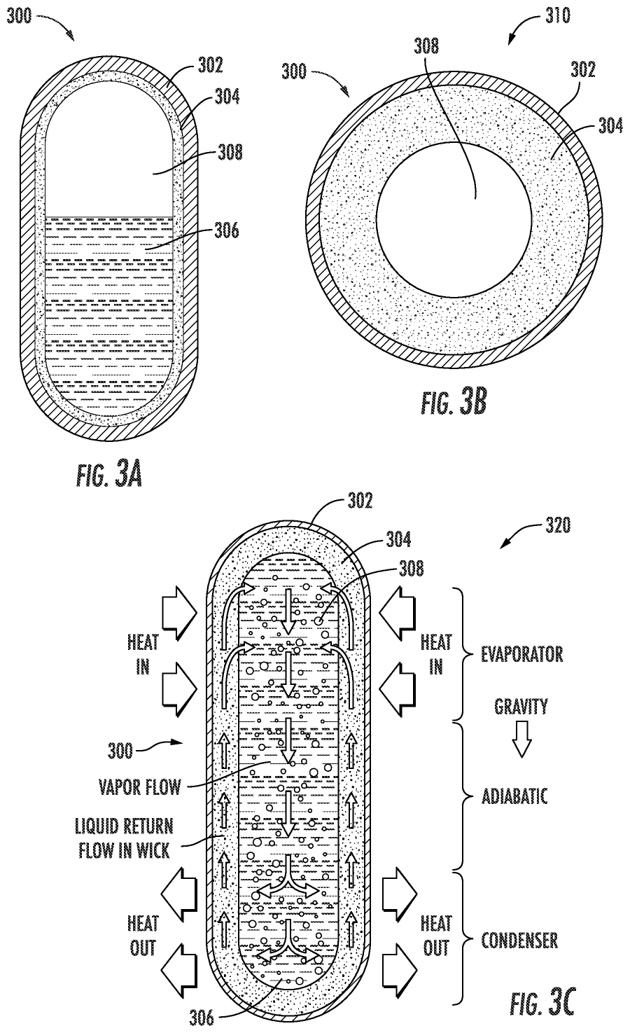

FIG. 2A illustrates an example vapor chamber 200 that may be manufactured in accordance with an embodiment of the invention. As shown in FIG. 2A, the vapor chamber 200 includes an outer shell 202 and a porous wicking structure 204 formed from powder positioned within the outer shell 202. Although not shown in FIG. 2A, the vapor chamber 200 may also include a liquid (e.g., water) within the outer shell 202. The vapor chamber 200 may be positioned such that a surface of the outer shell 202 is adjacent one or more surfaces of another device that generates heat, and the vapor chamber 200 may absorb and dissipate the heat to cool the other device (e.g., in a manner similar to that described herein with respect to FIG. 2B).

FIG. 2B is a diagram 210 depicting functions of another example vapor chamber 220, in accordance with an embodiment of the invention. As shown in FIG. 2B, the vapor chamber 220 includes an outer shell 222, a porous wicking structure 224 formed from powder positioned within the outer shell 222, a liquid 226 (e.g., water), and multiple cooling fins 228. The vapor chamber 220 is positioned such that the outer shell 222 is adjacent surfaces 212 and 214 of another device that generates heat.

As shown in FIG. 2B, the liquid 226 in an evaporator region of the porous wicking structure 224 near the surfaces 212 and 214 evaporates into a vapor due to the heat, and the vapor rises to a condenser region of the porous wicking structure 224. The heated vapor dissipates the heat into the condenser region and the upper surface of the outer shell 222. The cooling fins 228 further dissipate the heat from the outer shell 222 into the surrounding environment.

As shown in FIG. 2B, after dissipating the heat into the condenser region of the porous wicking structure 224, the vapor condenses into the liquid 226 within the porous wicking structure 224. The porous wicking structure 224 then wicks the newly condensed liquid 226 around the outer edges of the outer shell back to the evaporator region, where the heat evaporates the liquid 226 into a vapor and the cycle is repeated. Via this process, the vapor chamber 220 removes heat from the surfaces 212 and 214 to facilitate the maintenance of an operating temperature for the other device.

As will be appreciated by one of ordinary skill in the art in light of this disclosure, the number and arrangement of components shown in FIGS. 2A and 2B are provided as examples. In practice, the vapor chamber 200 of FIG. 2A and the vapor chamber 220 of FIG. 2B may include additional components, fewer components, different components, or differently arranged components than those shown in FIGS. 2A and 2B.

FIG. 2C illustrates an example of a conventional method 230 for manufacturing a vapor chamber (e.g., a vapor chamber similar to the example vapor chamber 200 of FIG. 2A and/or the example vapor chamber 220 of FIG. 2B). As shown in FIG. 2C, the method 230 may include a step 232 of manufacturing an outer shell 202 having a width W and a height H. In some embodiments, the method 230 also includes a step 234 of adding a fixed amount-by-weight of powder to the outer shell 202 to create a porous wicking structure 204 on an interior of the outer shell 202. As shown in FIG. 2C, the method 230 may include a step 236 of adding a fixed amount-by-weight of liquid 206 to the interior of the outer shell 202. Although only steps 232-236 are shown in FIG. 2C, the method 230 may include additional steps.

In the method 230, the width W, the height H, the amount-by-weight of powder, and the amount-by-weight of liquid 206 are fixed and selected, before performing the method 230, to achieve a vapor chamber that satisfies specifications and/or provides a given level of performance. However, each of the width W, the height H, the fixed amount-by-weight of powder, and the fixed amount-by-weight of liquid 206 includes a manufacturing tolerance as shown by the “±?” in FIG. 2C. Even though each step of the method 230 is performed to achieve one or more target values for attributes of the vapor chamber, the manufacturing tolerances introduce deviations from the target values. These deviations accumulate such that the vapor chamber ultimately produced may not satisfy specifications originally targeted by the selection of the target values and/or may not provide maximum heat dissipation performance. For example, the manufactured vapor chamber may not be capable of maintaining an operating temperature for a device on which it is positioned, be capable of operating in a range of environments, and/or the like.

FIG. 2D illustrates an example method 240 for manufacturing a vapor chamber (e.g., a vapor chamber similar to the example vapor chamber 200 of FIG. 2A and/or the example vapor chamber 220 of FIG. 2B), in accordance with an embodiment of the invention. As shown in FIG. 2D, the method 240 includes a step 242 of manufacturing an outer shell 202 having a width W and a height H. The method 240 also includes a step 244 of adding an artificial-intelligence-informed (AI-informed) amount-by-weight of powder to the outer shell 202 to create a porous wicking structure 204 on an interior of the outer shell 202. As shown in FIG. 2D, the method 240 includes a step 246 of adding an AI-informed amount-by-weight of liquid 206 to the interior of the outer shell 202. Although only steps 242-246 are shown in FIG. 2D, the method 240 may include additional steps.

Each of the width W and the height H, the AI-informed amount-by-weight of powder, and the AI-informed amount-by-weight of liquid 206 includes a manufacturing tolerance as shown by the “±?” in FIG. 2D. However, in contrast to the method of FIG. 2C, in FIG. 2D the actual values achieved by the preceding step(s) are provided to an artificial intelligence (AI) system, and the AI system (e.g., using one or more machine learning models) determines, based on the actual values, the amount-by-weight of powder and the amount-by-weight of liquid 206.

For example, and as shown in FIG. 2D, after performing the step 242 of manufacturing the outer shell 202, the actual width and the actual height are measured (e.g., by a system, by a machine, manually, and/or the like) and provided to the AI system. The AI system determines, based on the actual width and the actual height, the AI-informed amount-by-weight of powder to add in the step 244 to optimize performance of the vapor chamber.

As another example, and as shown in FIG. 2D, after performing the step 244, the actual amount-by-weight of powder is measured (e.g., weighed by a system, by a machine, manually, and/or the like) and provided to the AI system. The AI system determines, based on the actual amount-by-weight of powder, the AI-informed amount-by-weight of liquid to add in step 246 to optimize performance of the vapor chamber. In some embodiments, the method 240 may also include measuring a thickness of the porous wicking structure 204 formed on the interior of the outer shell 202 by the powder (e.g., measured by a system, by a machine, manually, and/or the like) and determining, based on the measured thickness, the AI-informed amount-by-weight of liquid to add in step 246 to optimize performance of the vapor chamber.

By using the actual values achieved by the preceding steps to determine a target value for the next step, the method 240 accounts for any deviations introduced to due manufacturing tolerances. Accounting for the deviations in this manner increases the likelihood that the vapor chamber will satisfy specifications, perform optimally, and/or the like. Furthermore, by using the AI system to determine the target values for subsequent steps, the method 240 further increases the likelihood that the vapor chamber will satisfy specifications, perform optimally, and/or the like.

In some embodiments, the AI system may use one or more machine learning models to determine, based on the actual values achieved by preceding steps, a target value for a next step in a method of manufacturing an object. In some embodiments, the one or more machine learning models may be trained using historical data associated with previously manufactured objects. As previously noted, the historical data may include actual values of attributes of previously manufactured objects, simulation inputs, analytical inputs, and/or historical measurement data of the previously manufactured objects, such that the machine learning models provide target specification values for each step to achieve optimal performance of the object. By using machine learning models to determine target values for each subsequent step in the process, the method improves the performance of the manufactured object as compared to objects made via manufacturing processes that do not use machine learning models and do not account for deviations from target values due to manufacturing tolerances.

FIG. 2E illustrates an example method 260 for manufacturing multiple vapor chambers, in accordance with an embodiment of the invention. As shown in FIG. 2E, the method 260 includes the same steps 242-246 as the method 240 of FIG. 2D. After performing steps 242-246, the method 260 includes a step 248 of testing the vapor chamber. For example, the step 248 may include performing thermal testing on the vapor chamber to determine whether the vapor chamber provides an appropriate level of heat dissipation, satisfies one or more specifications, satisfies one or more standards, and/or the like. The test result data may be stored and used as historical data for reference when manufacturing additional vapor chambers, when training machine learning models to determine target values for manufacturing steps, and/or the like.

As shown in FIG. 2E, the method 260 may include a step 250 of using the test result data to determine target values for a width W and a height H of an outer shell 202 of the next vapor chamber to be manufactured. The method 260 may also include a step 252 of using the test result data to determine an amount-by-weight of powder to add the outer shell 202 to create a porous wicking structure 204 for the next vapor chamber. For example, the step 252 may include retraining one or more machine learning models of the AI system using the test result data to improve the one or more machine learning models' ability to determine an amount-by-weight of powder to add to the interior of outer shell 202 to maximize performance of the next vapor chamber.

As shown in FIG. 2E, the method 260 may include a step 254 of using the test result data to determine an amount-by-weight of liquid 206 to add the interior of the outer shell 202. For example, the step 254 may include retraining one or more machine learning models of the AI system using the test result data to improve the one or more machine learning models' ability to determine an amount-by-weight of liquid 206 to add to the interior of outer shell 202 to maximize performance of the next vapor chamber.

In some embodiments, the method 260 may include repeating the steps 242-254 to manufacture multiple vapor chambers and to build a database including the test result data for the vapor chambers. The database may also include the actual width of the outer shell, the actual height of the outer shell, the actual amount-by-weight of powder, and the actual amount-by-weight of liquid for each of the vapor chambers as measured during the manufacturing of the vapor chambers. After building the database using data from manufacturing and testing multiple vapor chambers, the database may be used by the AI system to further improve the one or more machine learning models' ability to determine target values for steps during the manufacturing of vapor chambers. Furthermore, by continually updating the database with new data after each vapor chamber is manufactured and retraining the one or more machine learning models using the updated database, the AI system may iteratively improve the one or more machine learning models' ability to determine optimal target values that maximize performance of the manufactured vapor chambers.

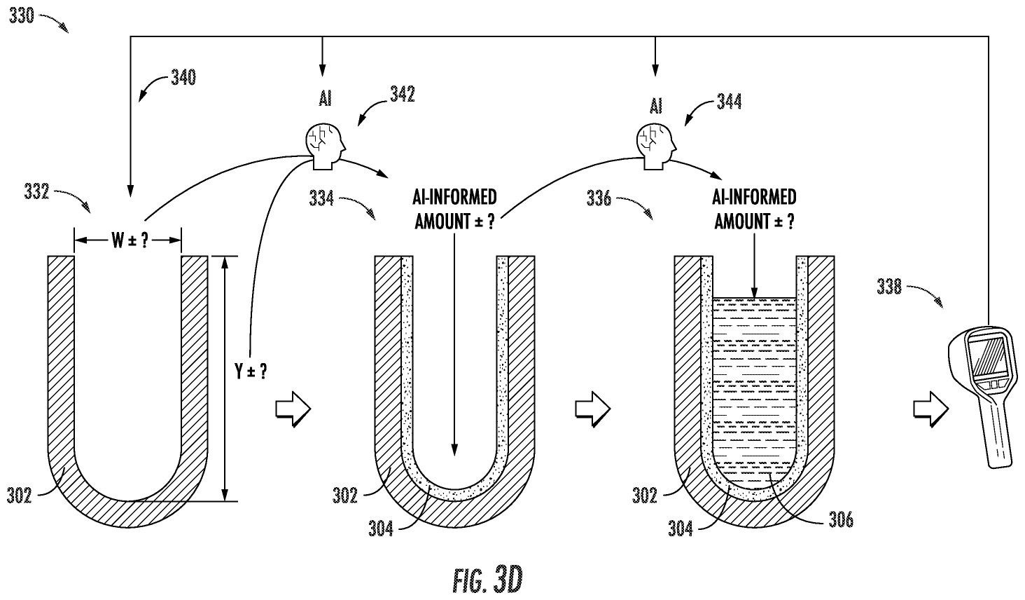

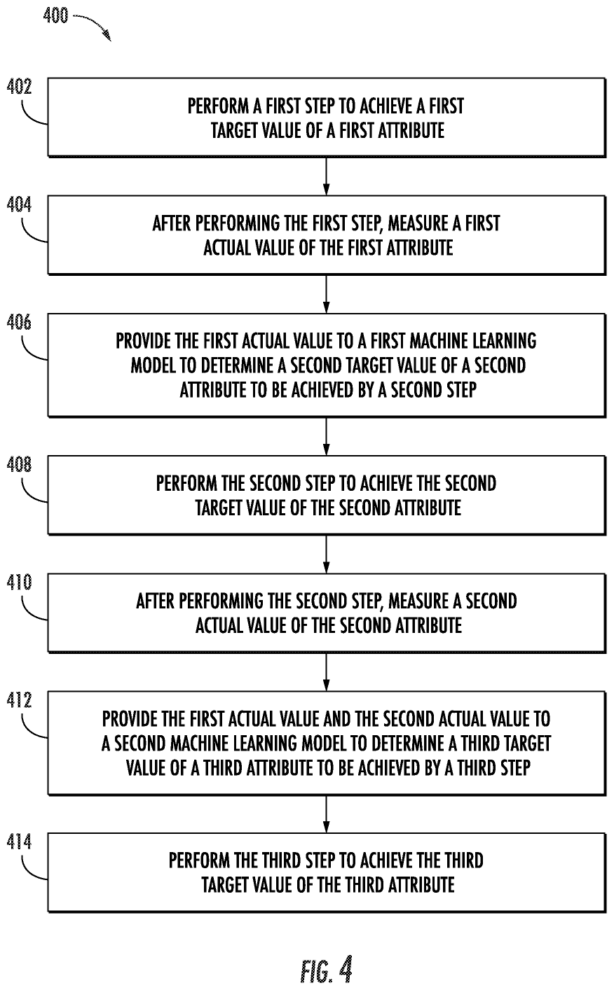

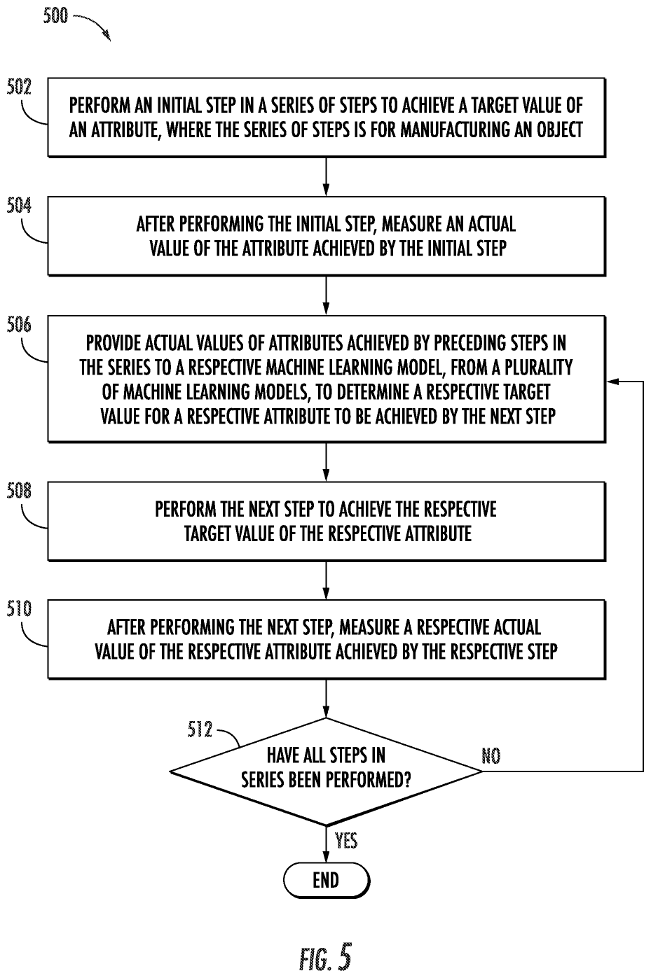

FIG. 3A illustrates an example heat pipe 300, in accordance with an embodiment of the invention. As shown in FIG. 3A, the heat pipe 300 may include a tubular outer shell 302 having a pipe-like (e.g., tubular) shape with closed ends, a porous wicking structure 304 formed from powder positioned within the tubular outer shell 302, a liquid 306 (e.g., water) positioned within the tubular outer shell 302, and a vapor space 308. The heat pipe 300 may be positioned such that an upper end (e.g., as oriented in FIG. 3A) is within an environment that generates heat, and the heat pipe 300 may absorb and dissipate the heat to cool the other device (e.g., in a manner similar to that described herein with respect to FIG. 3C).

FIG. 3B illustrates a cross-section 310 of the example heat pipe 300 of FIG. 3A, in accordance with an embodiment of the invention. As shown in FIG. 3B, the porous wicking structure 304 is formed on the interior surface of the tubular outer shell 302, and the vapor space 308 is centrally located within the porous wicking structure 304. Although not shown in FIG. 3B, the liquid 306 may also occupy a portion of the space within the porous wicking structure 304.

FIG. 3C is a diagram 320 depicting functions of the example heat pipe 300 of FIG. 3A, in accordance with an embodiment of the invention. As shown in FIG. 3C, the heat pipe 300 is positioned such that an upper end of heat pipe 300 is within an environment that generates heat. According to such embodiments, the liquid 306 in an evaporator region of the porous wicking structure 304 in the upper end of the heat pipe 300 evaporates into a vapor due to the heat, and the vapor falls centrally down the heat pipe 300 through an adiabatic region to a condenser region of the porous wicking structure 304. The heated vapor dissipates the heat into the condenser region, the lower end of the tubular outer shell 302, and into the surrounding environment.

As shown in FIG. 3C, after dissipating the heat into the condenser region of the porous wicking structure 304, the vapor condenses into the liquid 306 within the porous wicking structure 304. The porous wicking structure 304 then wicks the newly condensed liquid 306 around the outer edges of the tubular outer shell 302 back to the evaporator region, where the heat evaporates the liquid 306 into a vapor and the cycle is repeated. Via this process, the heat pipe 300 removes heat from the surrounding environment adjacent the upper end of the heat pipe 300.

As will be appreciated by one of ordinary skill in the art, the number and arrangement of components shown in FIGS. 3A-3C are provided as examples. In practice, the heat pipe 300 of FIGS. 3A-3C may include additional components, fewer components, different components, or differently arranged components than those shown in FIGS. 3A-3C.

FIG. 3D illustrates an example method 330 for manufacturing multiple heat pipes (e.g., heat pipes similar to the example heat pipe 300 of FIGS. 3A-3C), in accordance with an embodiment of the invention. As shown in FIG. 3D, embodiments of the method 330 include a step 332 of manufacturing a tubular outer shell 302 having a width W and a length Y. The method 330 may also include a step 334 of adding an artificial-intelligence-informed (AI-informed) amount-by-weight of powder to the tubular outer shell 302 to create a porous wicking structure 304 on an interior of the tubular outer shell 302. As shown in FIG. 3D, the method 330 may include a step 336 of adding an AI-informed amount-by-weight of liquid to the interior of the tubular outer shell 302. Although only steps 332-336 are shown in FIG. 3D for manufacturing a single heat pipe, the method 330 may include additional steps for manufacturing a single heat pipe.

Each of the width W and the length Y, the AI-informed amount-by-weight of powder, and the AI-informed amount-by-weight of liquid 306 includes a manufacturing tolerance as shown by the “±?” in FIG. 3D. However, according to embodiments described herein, the actual values achieved by the preceding steps are provided to an artificial intelligence (AI) system, and the AI system (e.g., using one or more machine learning models) determines, based on the actual values, the amount-by-weight of powder and the amount-by-weight of liquid 306.

For example, and as shown in FIG. 3D, after performing the step 332 of manufacturing the tubular outer shell 302, the actual width and the actual length are measured (e.g., by a system, by a machine, manually, and/or the like) and provided to the AI system. According to embodiments of the invention, the AI system determines, based on the actual width and the actual length, the AI-informed amount-by-weight of powder to add in the step 334 to optimize performance of the heat pipe.

As another example, and as shown in FIG. 3D, after performing the step 334, the actual amount-by-weight of powder may be measured (e.g., weighed by a system, by a machine, manually, and/or the like)) and provided to the AI system. The AI system may determine, based on the actual amount-by-weight of powder, the AI-informed amount-by-weight of liquid to add in step 336 to optimize performance of the heat pipe. In some embodiments, the method 330 may also include measuring a thickness of the porous wicking structure 304 formed on the interior of the tubular outer shell 302 by the powder and determining, based on the measured thickness, the AI-informed amount-by-weight of liquid to add in step 336 to optimize performance of the vapor chamber.

By using the actual values achieved by the preceding step(s) to determine a target value for the next step, embodiments of the method 330 account for any deviations introduced due to manufacturing tolerances. Accounting for the deviations in this manner increases the likelihood that the heat pipe will satisfy specifications, perform optimally, and/or the like. Furthermore, by using the AI system to determine the target values for subsequent steps, the method 330 further increases the likelihood that the heat pipe will satisfy specifications, perform optimally, and/or the like. In some embodiments, the AI system may use one or more machine learning models to determine, based on the actual values achieved by preceding steps, a target value for a next step in a method of manufacturing an object as previously described with respect to FIG. 2D.

As shown in FIG. 3D, after performing steps 332-336, the method 330 may include a step 338 of testing the heat pipe. For example, the step 338 may include performing thermal testing on the heat pipe to determine whether the heat pipe provides an appropriate level of heat dissipation, satisfies one or more specifications, satisfies one or more standards, and/or the like. The test result data may be stored and used as historical data for reference when manufacturing additional heat pipes, when training machine learning models to determine target values for manufacturing steps, and/or the like.

As shown in FIG. 3D, the method 330 may include a step 340 of using the test result data to determine target values for a width W and a length Y of a tubular outer shell 302 of the next heat pipe to be manufactured. The method 330 may also include a step 342 of using the test result data to determine an amount-by-weight of powder to add the tubular outer shell 302 to create a porous wicking structure 304 for the next heat pipe. For example, the step 342 may include retraining one or more machine learning models of the AI system using the test result data to improve the one or more machine learning models' ability to determine an amount-by-weight of powder to add to the interior of the tubular outer shell 302 to maximize performance of the next heat pipe.

As shown in FIG. 3D, the method 330 may include a step 344 of using the test result data to determine an amount-by-weight of liquid 306 to add the interior of the tubular outer shell 302. For example, the step 344 may include retraining one or more machine learning models of the AI system using the test result data to improve the one or more machine learning models' ability to determine an amount-by-weight of liquid 306 to add to the interior of outer shell 302 to maximize performance of the next heat pipe.

In some embodiments, the method 330 may include repeating the steps 332-344 to manufacture multiple heat pipes and to build a database including the test result data for the heat pipes. The database may also include the actual width of the outer shell, the actual length of the outer shell, the actual amount-by-weight of powder, and the actual amount-by-weight of liquid for each of the heat pipes as measured during the manufacturing of the heat pipes. After building the database using data from manufacturing and testing multiple heat pipes, the database may be used by the AI system to further improve the one or more machine learning models' ability to determine target values for steps during the manufacturing of heat pipes. Furthermore, by continually updating the database with new data after each heat pipe is manufactured and retraining the one or more machine learning models using the updated database, the AI system may iteratively improve the one or more machine learning models' ability to determine optimal target values that maximize performance of the manufactured heat pipes.

FIG. 4 illustrates an example method 400 for manufacturing an object, in accordance with an embodiment of the invention. In some embodiments, one or more manufacturing systems may perform one or more of the steps of the method 400. The object may be, for example, a vapor chamber as described with respect to FIGS. 2A-2E, a heat pipe as described with respect to FIGS. 3A-3D, a semiconductor-based device, a silicon-based device, a product, and/or any other object manufactured via a process.

As shown in block 402, the method 400 may include performing a first step to achieve a first target value of a first attribute. In some embodiments, the first attribute may be a dimension (e.g., height, width, length, volume, radius, diameter, circumference, perimeter, area, weight, and/or the like), a property, a characteristic, a quality, a trait, a feature, a condition, and/or the like of the object, a component of the object, an intermediate component of the object during the manufacturing process, and/or the like. For example, the object may be a vapor chamber, and the first attribute may be a height, width, length, volume, and/or the like of an outer shell of the vapor chamber during the manufacturing process and before the vapor chamber is completed.

As shown in block 404, the method 400 may include, after performing the first step, measuring a first actual value of the first attribute. In an embodiment where the first attribute is a dimension, a property, a characteristic, a quality, a trait, a feature, and/or a condition of a component of the object, the method 400 may include measuring an actual value of the dimension, the property, the characteristic, the quality, the trait, the feature, and/or the condition of the component, such as described above. For example, when the first attribute is the height of an outer shell of a vapor chamber, the method may include measuring the actual height of the outer shell after manufacturing the outer shell.

As shown in block 406, the method 400 may include providing the first actual value to a first machine learning model to determine a second target value of a second attribute to be achieved by a second step. In some embodiments, the second attribute, like the first attribute, may be a dimension (e.g., height, width, length, volume, radius, diameter, circumference, perimeter, area, weight, and/or the like), a property, a characteristic, a quality, a trait, a feature, a condition, and/or the like of the object, a component of the object, an intermediate component of the object during the manufacturing process, and/or the like. Using the example of a vapor chamber as the object, the second attribute may be an amount-by-weight of powder to be added to the outer shell to create a porous wicking structure on an interior of the outer shell. In such an example, the method may include providing actual values of one or more dimensions of the outer shell to a machine learning model, where the machine learning model is trained to determine amounts-by-weight of powder to be added to outer shells to optimize performance of the vapor chamber.

As shown in block 408, the method 400 may include performing the second step to achieve the second target value of the second attribute. Again, using the example of a vapor chamber as the object, the method 400 may include adding an amount-by-weight of powder to the outer shell to create a porous wicking structure on the interior of the outer shell, where the amount-by-weight of powder was determined by the machine learning model.

As shown in block 410, the method 400 may include, after performing the second step, measuring a second actual value of the second attribute. For example, the method may include measuring (e.g., by weighing) an actual amount-by-weight of powder added to the outer shell.

As shown in block 412, the method 400 may include providing the first actual value and the second actual value to a second machine learning model to determine a third target value of a third attribute to be achieved by a third step. In some embodiments, the third attribute, like the first and second attributes, may be a dimension (e.g., height, width, length, volume, radius, diameter, circumference, perimeter, area, weight, and/or the like), a property, a characteristic, a quality, a trait, a feature, a condition, and/or the like of the object, a component of the object, an intermediate component of the object during the manufacturing process, and/or the like. Using the example of a vapor chamber as the object, the third attribute may be an amount-by-weight of liquid to be added to the interior of the outer shell. In such an example, the method may include providing actual values of one or more dimensions of the outer shell and the actual amount-by-weight of powder to a machine learning model, where the machine learning model is trained to determine amounts-by-weight of water to be added to outer shells to optimize performance of the vapor chamber.

As shown in block 414, the method 400 may include performing the third step to achieve the third target value of the third attribute. Again, using the example of a vapor chamber as the object, the method may include adding an amount-by-weight of liquid to the outer shell, where the amount-by-weight of liquid was determined by the machine learning model.

Method 400 may include additional embodiments, such as any single embodiment or any combination of embodiments described herein. Although FIG. 4 shows example blocks of method 400, in some embodiments, method 400 may include additional blocks, fewer blocks, different blocks, or differently arranged blocks than those depicted in FIG. 4. Additionally, or alternatively, two or more of the blocks of method 400 may be performed in parallel.

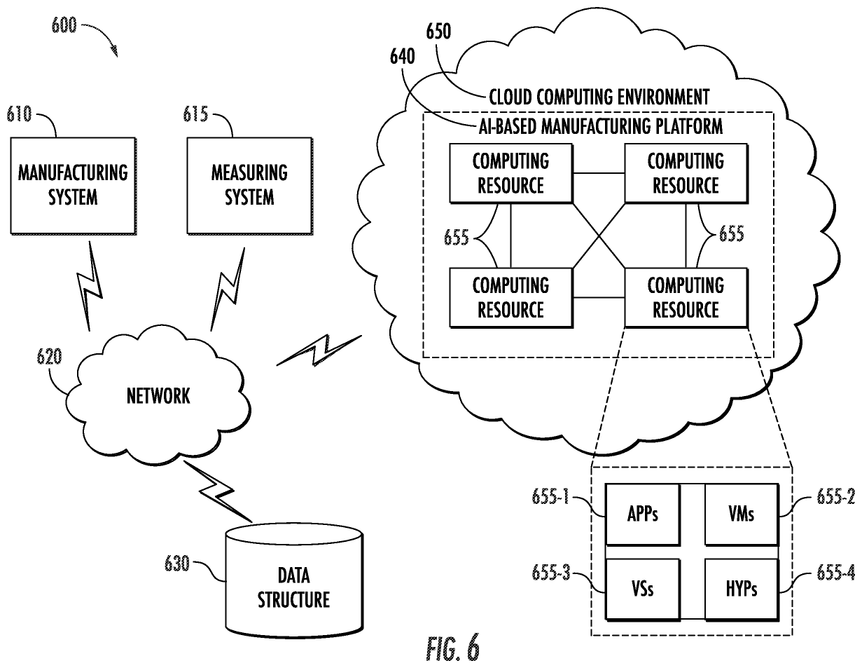

FIG. 5 illustrates an example method 500 for manufacturing an object, in accordance with an embodiment of the invention. In some embodiments, one or more manufacturing systems may perform one or more of the steps of the method 500. The object may be, for example, a vapor chamber as described with respect to FIGS. 2A-2E, a heat pipe as described with respect to FIGS. 3A-3D, a semiconductor-based device, a silicon-based device, a product, and/or any other object manufactured via a process.

As shown in block 502, the method 500 may include performing an initial step in a series of steps to achieve a target value of an attribute, where the series of steps is for manufacturing an object. In some embodiments, the attribute may be a dimension (e.g., height, width, length, volume, radius, diameter, circumference, perimeter, area, weight, and/or the like), a property, a characteristic, a quality, a trait, a feature, a condition, and/or the like of the object, a component of the object, an intermediate component of the object during the manufacturing process, and/or the like. For example, the object may be a heat pipe, and the attribute may be a height, width, length, volume, and/or the like of a tubular outer shell of the heat pipe during the manufacturing process and before the heat pipe is completed.

As shown in block 504, the method 500 may include, after performing the initial step, measuring an actual value of the attribute achieved by the initial step. In an embodiment where the attribute is a dimension, a property, a characteristic, a quality, a trait, a feature, and/or a condition of a component of the object, the method 500 may include measuring an actual value of the dimension, the property, the characteristic, the quality, the trait, the feature, and/or the condition of the component. For example, when the attribute is the volume of a tubular outer shell of a heat pipe, the method may include measuring the actual volume of the tubular outer shell after manufacturing the tubular outer shell.

As shown in block 506, the method 500 may include providing actual values of attributes achieved by preceding steps in the series to a respective machine learning model, from a plurality of machine learning models, to determine a respective target value for a respective attribute to be achieved by the next step. For example, for a second step after the initial step, the method 500 may include providing the actual value of the attribute (e.g., the measured volume of the tubular outer shell) achieved by the initial step to a first machine learning model to determine a target value of an attribute to be achieved by the second step (e.g., an amount-by-weight of powder to be added to the tubular outer shell to create a porous wicking structure on an interior of the outer shell).

As shown in block 508, the method 500 may include performing the next step to achieve the respective target value of the respective attribute. For example, for a second step after the initial step, the method 500 may include performing the second step to achieve a target value of another attribute (e.g., an amount-by-weight of powder to be added to the tubular outer shell of a heat pipe to create a porous wicking structure on an interior of the tubular outer shell), where the target value was determined by a machine learning model based on the actual value achieved by the initial step (e.g., the measured volume of the tubular outer shell of a heat pipe).

As shown in block 510, the method 500 may include, after performing the next step, measuring a respective actual value of the respective attribute achieved by the respective step. For example, for a second step, the method 500 may include, after performing the second step, measuring an actual value of the other attribute achieved by the second step (e.g., an actual amount-by-weight of powder added to the tubular outer shell of the heat pipe to create the porous wicking structure on the interior of the outer shell).

As shown in diamond 512, the method 500 may include determining whether all steps in the series have been performed. For example, the method 500 may include determining if the most recently performed step is a last step in the series, determining if additional steps should be performed to complete manufacturing the object, and/or the like.

As shown in FIG. 5, based on determining that all steps in the series have not been performed, the method 500 may include repeating the steps of blocks 506, 508, and 510 as well as diamond 512. For example, the method 500 may include repeating block 506 for a third step after the second step, by providing the actual values of the attributes achieved by the initial step and the second step (e.g., the measured volume of the tubular outer shell and a measured amount-by-weight of powder added to the outer shell) to another machine learning model to determine a target value of another attribute to be achieved by the third step (e.g., an amount-by-weight of liquid to be added to the interior of the tubular outer shell). Additionally, or alternatively, the method 500 may include repeating block 508 for the third step by performing the third step to achieve a target value of another attribute (e.g., an amount-by-weight of liquid to be added to the interior of the tubular outer shell), where the target value was determined by a machine learning model based on the actual value achieved by the initial step (e.g., the measured volume of the tubular outer shell of a heat pipe) and the actual value achieved by the second step (e.g., the measured amount-by-weight of powder added to the tubular outer shell). Furthermore, the method 500 may include repeating block 510 for the third step by, after performing the third step, measuring an actual value of the other attribute achieved by the third step (e.g., an actual amount-by-weight of liquid added to the interior of the tubular outer shell). The method 500 may also include repeating diamond 512 for the third step by determining whether all steps in the series have been performed. In this way, the method 500 may include performing subsequent steps in the series to manufacture the object by repeating the steps of blocks 506, 508, and 510 as well as diamond 512.

As shown in FIG. 5, based on determining that all steps in the series have been performed, the method 500 may include ending the manufacturing process. In some embodiments, and as described herein with respect to the examples of FIGS. 2E and 3D, the method 500 may also include, after manufacturing the object, performing one or more tests on the object to obtain test results. Additionally, or alternatively, the method 500 may include retraining the plurality of machine learning models of block 506 using data including the actual values measured in block 510 and the test results.

Method 500 may include additional embodiments, such as any single embodiment or any combination of embodiments described herein. Although FIG. 5 shows example blocks of method 500, in some embodiments, method 500 may include additional blocks, fewer blocks, different blocks, or differently arranged blocks than those depicted in FIG. 5. Additionally, or alternatively, two or more of the blocks of method 500 may be performed in parallel.

As noted, embodiments of the present invention may include using artificial intelligence including one or more machine learning models. In this regard, the artificial intelligence and/or the machine learning models may be trained using historical data that includes historical actual values measured after performance of steps to manufacture historical objects, historical test results obtained by testing the historical objects, historical measurements performed on the historical objects, and/or the like. In some embodiments, the artificial intelligence and/or the machine learning models may be trained using one or more reinforcement learning algorithms, such as one or more Q-learning algorithms. Additionally, or alternatively, the artificial intelligence and/or the machine learning models may include one or more Siamese neural networks.

In some embodiments, the artificial intelligence and/or the machine learning models may determine target values for attributes by running a plurality of simulations using (i) the actual values of attributes achieved by preceding steps and (ii) manufacturing tolerances of the subsequent steps. For example, the artificial intelligence may use measured values achieved by previous steps and run multiple simulations that account for the manufacturing tolerances of steps that have not yet been performed to determine, for a next step in the manufacturing process, a target value that has the highest likelihood of achieving an object with optimal performance, characteristics, specifications, and/or the like.

FIG. 6 illustrates a system environment 600 for artificial-intelligence-based manufacturing, in accordance with an embodiment of the invention. As shown in FIG. 6, the system environment 600 may include a manufacturing system 610 (e.g., one or more systems and/or devices for manufacturing objects and/or the like), a measuring system 615 (e.g., one or more systems and/or devices for measuring attributes, one or more systems and/or devices for testing objects to obtain test results, and/or the like), a network 620, a data structure 630, an artificial-intelligence-based (AI-based) manufacturing platform 640, and a cloud computing environment 650 with computing resources 655. Devices of environment 600 may interconnect via wired connections, wireless connections, or a combination of wired and wireless connections. Devices of environment 600 may perform one or more of the steps of one or more of the methods described herein (e.g., with respect to FIGS. 1B, 2D, 2E, 3D, 4, and 5).

In some embodiments, the manufacturing system 610 may include one or more devices capable of receiving instructions for and/or executing such instructions to manufacture objects. For example, the manufacturing system 610 may include one or more tools for manufacturing one or more objects, such as vapor chambers, heat pipes, semiconductor-based devices, silicon-based devices, products, and/or any other object manufactured via a process.

In some embodiments, the measuring system 615 may include one or more devices capable of measuring attributes of objects, components of objects, intermediate components of objects during manufacturing, and/or the like. For example, the measuring system 615 may include one or more devices for measuring dimensions (e.g., heights, widths, lengths, volumes, radii, diameters, circumferences, perimeters, areas, weights, and/or the like), properties, characteristics, qualities, traits, features, conditions, and/or the like of objects, components of objects, intermediate components of objects during manufacturing, and/or the like.

The network 620 may include one or more wired and/or wireless networks. For example, the network 620 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The data structure 630 may include any type of data structure (e.g., a database, an array, a linked list, a record, a hash table, and/or the like) for storing data. In some embodiments, the data structure 630 may be maintained on-site with the manufacturing system 610 and/or the measuring system 615. Additionally, or alternatively, the data structure 630 may be cloud-based and may be stored remotely from the manufacturing system 610 and/or the measuring system 615.

In some embodiments, the AI-based manufacturing platform 640 may include one or more computing resources assigned to determine target values of manufacturing steps and/or the like, as described herein (e.g., with respect to FIGS. 1B, 2D, 2E, 3D, 4, and 5). For example, the AI-based manufacturing platform 640 may be a platform implemented by the cloud computing environment 650 that may receive actual values (e.g., measured values) of attributes, train machine learning models, determine target values for subsequent manufacturing steps, access and/or store data in the data structure 630, and/or the like. In some embodiments, the AI-based manufacturing platform 640 may be implemented by computing resources 655 of the cloud computing environment 650.

The AI-based manufacturing platform 640 may include a server device or a group of server devices. In some embodiments, AI-based manufacturing platform 640 may be hosted in cloud computing environment 650. Notably, while embodiments described herein describe the AI-based manufacturing platform 640 as being hosted in cloud computing environment 650, in some embodiments, the AI-based manufacturing platform 640 may be non-cloud-based or may be partially cloud-based.

The cloud computing environment 650 may include an environment that delivers computing as a service, whereby shared resources, services, etc. may be provided to other devices, such as the manufacturing system 610, the measuring system 615, and/or the like. The cloud computing environment 650 may provide computation, software, data access, storage, and/or other services that do not require end-user knowledge of a physical location and configuration of a system and/or a device that delivers the services. As shown, the cloud computing environment 650 may include the AI-based manufacturing platform 640 and the computing resource 655.

The computing resource 655 may include one or more personal computers, workstation computers, server devices, or another type of computation and/or communication device. In some embodiments, the computing resource 655 may host the AI-based manufacturing platform 640. The cloud resources may include compute instances executing in the computing resource 655, storage devices provided in the computing resource 655, data transfer devices provided by the computing resource 655, etc. In some embodiments, the computing resource 655 may communicate with other computing resources 655 via wired connections, wireless connections, or a combination of wired and wireless connections.

As further shown in FIG. 6, the computing resource 655 may include a group of cloud resources, such as one or more applications (“APPs”) 655-1, one or more virtual machines (“VMs”) 655-2, virtualized storage (“VSs”) 655-3, one or more hypervisors (“HYPs”) 655-4, or the like.

The application 655-1 may include one or more software applications that may be provided to or accessed by devices, such as the manufacturing system 610 and/or the measuring system 615. The application 655-1 may eliminate a need to install and execute the software applications on devices, such as the manufacturing system 610 and/or the measuring system 615. For example, the application 655-1 may include software associated with the AI-based manufacturing platform 640 and/or any other software capable of being provided via the cloud computing environment 650. In some embodiments, one application 655-1 may send and/or receive information to and/or from one or more other applications 655-1 via virtual machine 655-2.

The virtual machine 655-2 may include a software implementation of a machine (e.g., a computer) that executes programs like a physical machine. The virtual machine 655-2 may be either a system virtual machine or a process virtual machine, depending upon use and degree of correspondence to any real machine by the virtual machine 655-2. A system virtual machine may provide a complete system platform that supports execution of a complete operating system (“OS”). A process virtual machine may execute a single program and may support a single process. In some embodiments, the virtual machine 655-2 may execute on behalf of a user (e.g., devices, such as the manufacturing system 610, the measuring system 615, the AI-based manufacturing platform 640, and/or the like) and may manage infrastructure of the cloud computing environment 650, such as data management, synchronization, or long-duration data transfers.

The virtualized storage 655-3 may include one or more storage systems and/or one or more devices that use virtualization techniques within the storage systems or devices of the computing resource 655. In some embodiments, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 655-4 may provide hardware virtualization techniques that allow multiple operating systems (e.g., “guest operating systems”) to execute concurrently on a host computer, such as the computing resource 655. The hypervisor 655-4 may present a virtual operating platform to the guest operating systems and may manage the execution of the guest operating systems. Multiple instances of a variety of operating systems may share virtualized hardware resources.

The number and arrangement of devices and networks shown in FIG. 6 are provided as one or more examples. In practice, there may be additional devices and/or networks, fewer devices and/or networks, different devices and/or networks, or differently arranged devices and/or networks than those shown in FIG. 6. Furthermore, two or more devices and/or systems shown in FIG. 6 may be implemented within a single device and/or a single system, or a single device and/or a single system shown in FIG. 6 may be implemented as multiple, distributed devices. Additionally or alternatively, a set of devices (e.g., one or more devices) of the environment 600 may perform one or more functions described as being performed by another set of devices of the environment 600.

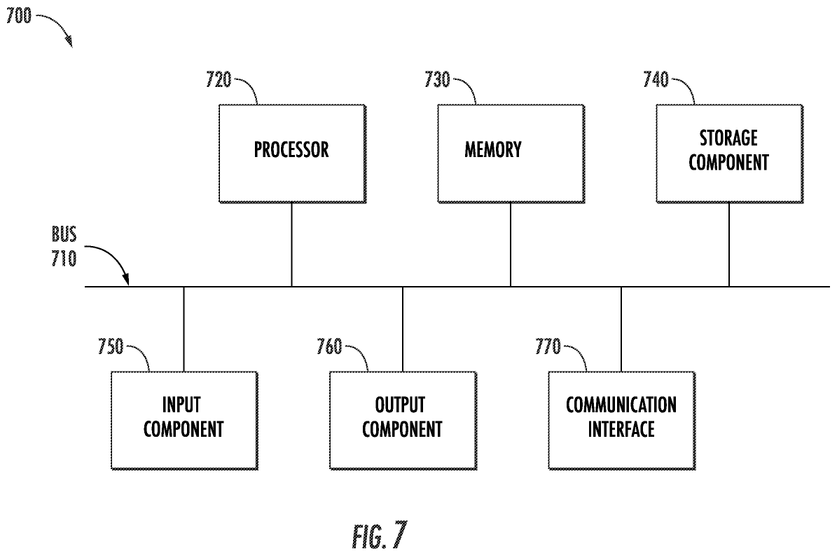

FIG. 7 is a diagram of example components of a device 700. In some embodiments, the device 700 may correspond to the manufacturing system, the measuring system, and/or the AI-based manufacturing platform described herein with respect to FIGS. 1-6. Additionally or alternatively, the manufacturing system, the measuring system, and/or the AI-based manufacturing platform described herein with respect to FIGS. 1-6 may include one or more devices 700 and/or one or more components of the device 700. As shown in FIG. 7, the device 700 may include a bus 710, a processor 720, a memory 730, a storage component 740, an input component 750, an output component 760, and a communication interface 770.

Bus 710 may include a component that permits communication among multiple components of the device 700. The processor 720 may be implemented in hardware, firmware, and/or a combination of hardware and software. The processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 720 may include one or more processors capable of being programmed to perform a function. The memory 730 may include a random access memory (RAM), a read only memory (ROM), and/or another type of dynamic or static storage device (e.g., a flash memory, a magnetic memory, and/or an optical memory) that stores information and/or instructions for use by the processor 720.

The storage component 740 may store information and/or software related to the operation and use of the device 700. For example, the storage component 740 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

The input component 750 may include a component that permits the device 700 to receive information, such as via user input (e.g., a touch screen display, a keyboard, a keypad, a mouse, a button, a switch, and/or a microphone). Additionally or alternatively, the input component 750 may include a component for determining location (e.g., a global positioning system (GPS) component) and/or a sensor (e.g., an accelerometer, a gyroscope, an actuator, another type of positional or environmental sensor, and/or the like). The output component 760 may include a component that provides output information from the device 700 (via, e.g., a display, a speaker, a haptic feedback component, an audio or visual indicator, and/or the like).

The communication interface 770 may include a transceiver-like component (e.g., a transceiver, a separate receiver, a separate transmitter, and/or the like) that enables the device 700 to communicate with other devices, such as via a wired connection, a wireless connection, or a combination of wired and wireless connections. The communication interface 770 may permit the device 700 to receive information from another device and/or provide information to another device. For example, the communication interface 770 may include an Ethernet interface, an optical interface, a coaxial interface, an infrared interface, a radio frequency (RF) interface, a universal serial bus (USB) interface, a Wi-Fi interface, a cellular network interface, and/or the like.

The device 700 may perform one or more processes described herein. The device 700 may perform these processes based on the processor 720 executing software instructions stored by a non-transitory computer-readable medium, such as the memory 730 and/or the storage component 740. As used herein, the term “computer-readable medium” refers to a non-transitory memory device. A memory device includes memory space within a single physical storage device or memory space spread across multiple physical storage devices.

Software instructions may be read into the memory 730 and/or the storage component 740 from another computer-readable medium or from another device via the communication interface 770. When executed, software instructions stored in the memory 730 and/or the storage component 740 may cause the processor 720 to perform one or more processes described herein. Additionally, or alternatively, hardware circuitry may be used in place of or in combination with software instructions to perform one or more processes described herein. Thus, embodiments described herein are not limited to any specific combination of hardware circuitry and software.

The number and arrangement of components shown in FIG. 7 are provided as an example. In practice, the device 700 may include additional components, fewer components, different components, or differently arranged components than those shown in FIG. 7. Additionally or alternatively, a set of components (e.g., one or more components) of the device 700 may perform one or more functions described as being performed by another set of components of the device 700.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor and/or a processing device, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium and/or a non-transitory storage device, such as a tangible electronic, magnetic, optical, electromagnetic, infrared, and/or semiconductor system, device, and/or other apparatus. For example, in some embodiments, the non-transitory computer-readable medium and/or the non-transitory storage device may include a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa.

While certain example embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

What is claimed is:

1. A method of manufacturing an object, the method comprising:
performing a first step to achieve a first target value of a first attribute;
after performing the first step, measuring a first actual value of the first attribute;
providing the first actual value to a first machine learning model to determine a second target value of a second attribute to be achieved by a second step;
performing the second step to achieve the second target value of the second attribute;
after performing the second step, measuring a second actual value of the second attribute;
providing the first actual value and the second actual value to a second machine learning model to determine a third target value of a third attribute to be achieved by a third step; and
performing the third step to achieve the third target value of the third attribute.

2. The method of claim 1, wherein the first step has a first manufacturing tolerance, the second step has a second manufacturing tolerance, and the third step has a third manufacturing tolerance.

3. The method of claim 1, wherein performing the first step comprises performing the first step to achieve the first target value of the first attribute and to achieve a fourth target value of a fourth attribute.

4. The method of claim 1, further comprising:
training the first machine learning model using first historical data comprising (i) historical first actual values of first attributes of historical objects and (ii) historical test results obtained by testing the historical objects; and
training the second machine learning model using second historical data comprising (i) the historical first actual values of the first attributes of the historical objects, (ii) historical second actual values of second attributes of the historical objects, and (iii) the historical test results.

5. The method of claim 1, further comprising, after performing the third step:
performing one or more tests on the object to obtain test results;
retraining the first machine learning model using the first actual value and the test results; and
retraining the second machine learning model using the first actual value, the second actual value, and the test results.

6. The method of claim 1, wherein:
the first machine learning model determines the second target value of the second attribute by running a first plurality of simulations using the first actual value of the first attribute and a second manufacturing tolerance of the second step; and
the second machine learning model determines the third target value of the third attribute by running a second plurality of simulations using the first actual value of the first attribute, the second actual value of the second attribute, and a third manufacturing tolerance of the third step.

7. The method of claim 1, wherein the object is a vapor chamber, wherein the first step comprises manufacturing an outer shell, wherein the second step comprises adding powder to the outer shell to create a porous wicking structure on an interior of the outer shell, and wherein the third step comprises adding water to the interior of the outer shell.

8. The method of claim 7, wherein:
the first attribute comprises a height and a width of the outer shell;
the second attribute is an amount-by-weight of the powder; and
the third attribute is an amount-by-weight of the water.

9. The method of claim 1, wherein the object is a heat pipe, wherein the first step comprises manufacturing a tubular outer shell, wherein the second step comprises adding powder to the tubular outer shell to create a porous wicking structure on an interior of the tubular outer shell, and wherein the third step comprises adding water to the interior of the tubular outer shell.

10. The method of claim 9, wherein:
the first attribute comprises a length and an inner circumference of the tubular outer shell;
the second attribute is an amount-by-weight of the powder; and
the third attribute is an amount-by-weight of the water.

11. A method of manufacturing an object, the method comprising:
performing an initial step in a series of steps to achieve a target value of an attribute, wherein the series of steps is for manufacturing an object;
after performing the initial step, measuring an actual value of the attribute achieved by the initial step; and
performing subsequent steps in the series to manufacture the object by, for each step:
providing actual values of attributes achieved by preceding steps in the series to a respective machine learning model, from a plurality of machine learning models, to determine a respective target value for a respective attribute to be achieved by the respective step;
performing the respective step to achieve the respective target value of the respective attribute; and
after performing the respective step, measuring a respective actual value of the respective attribute achieved by the respective step.

12. The method of claim 11, wherein each step in the series of steps has a respective manufacturing tolerance.

13. The method of claim 11, wherein at least one step in the series of steps is intended to achieve multiple target values for respective attributes.

14. The method of claim 11, wherein the plurality of machine learning models is trained using historical data comprising (i) historical actual values measured after historical performance of each step of the steps to manufacture historical objects and (ii) historical test results obtained by testing the historical objects.

15. The method of claim 11, further comprising, after performing the series of steps:
performing one or more tests on the object to obtain test results; and
retraining the plurality of machine learning models using data comprising actual values measured after performance of each step of the series of steps and the test results.

16. The method of claim 11, wherein the plurality of machine learning models determines respective target values for respective attributes by running a plurality of simulations using (i) the respective actual values of attributes achieved by preceding steps and (ii) manufacturing tolerances of the subsequent steps.

17. The method of claim 11, wherein the plurality of machine learning models is trained using one or more reinforcement learning algorithms.

18. The method of claim 17, wherein the plurality of machine learning models is trained using one or more Q-learning algorithms.

19. The method of claim 11, wherein the plurality of machine learning models comprises Siamese neural networks.

20. The method of claim 11, wherein the object is a vapor chamber, and wherein the series of steps comprises a first step of manufacturing an outer shell, a second step of adding powder to the outer shell to create a porous wicking structure on an interior of the outer shell, and a third step of adding water to the interior of the outer shell.

21. The method of claim 20, wherein:
the first step is to achieve first respective target values for a height and a width of the outer shell;
a second respective target value to be achieved by the second step is an amount-by-weight of the powder; and
a third respective target value to be achieved by the third step is an amount-by-weight of the water.

22. The method of claim 21, wherein the plurality of machine learning models is trained using historical data comprising:
historical heights of outer shells of historical vapor chambers;
historical widths of outer shells of the historical vapor chambers;
historical amounts-by-weight of powder of the historical vapor chambers;
historical amounts-by-weight of water in the historical vapor chambers; and
historical thermal testing results obtained by thermally testing the historical vapor chambers.

23. The method of claim 21, further comprising, after performing the series of steps:
performing thermal testing on the vapor chamber to obtain thermal testing results; and
retraining the plurality of machine learning models using the height of the outer shell, the width of the outer shell, the amount-by-weight of the powder, the amount-by-weight of the water, and the thermal testing results.

24. The method of claim 11, wherein the object is a heat pipe, and wherein the series of steps comprises a first step of manufacturing a tubular outer shell, a second step of adding powder to the tubular outer shell to create a porous wicking structure on an interior of the tubular outer shell, and a third step of adding water to the interior of the tubular outer shell.

25. The method of claim 24, wherein:
the first step is to achieve first respective values for a length and an inner circumference of the tubular outer shell;
a second respective target value to be achieved by the second step is an amount-by-weight of the powder; and
a third respective target value to be achieved by the third step is an amount-by-weight of the water.

26. The method of claim 25, wherein the plurality of machine learning models is trained using historical data comprising:
historical lengths of tubular outer shells of historical heat pipes;
historical inner circumferences of tubular outer shells of the historical heat pipes;
historical amounts-by-weight of powder of the historical heat pipes;
historical amounts-by-weight of water in the historical heat pipes; and
historical thermal testing results obtained by thermally testing the historical heat pipes.

27. The method of claim 25, further comprising, after performing the series of steps:
performing thermal testing on the heat pipe to obtain thermal testing results; and
retraining the plurality of machine learning models using the length of the tubular outer shell, the inner circumference of the tubular outer shell, the amount-by-weight of the powder, the amount-by-weight of the water, and the thermal testing results.

28. A system for manufacturing an object, the system comprising:
at least one processing device; and
at least one non-transitory storage device comprising computer-executable program code that, when executed by the at least one processing device, causes the at least one processing device to:
perform an initial step in a series of steps to achieve a target value of an attribute, wherein the series of steps is for manufacturing an object;
after performing the initial step, measure an actual value of the attribute achieved by the initial step; and
perform subsequent steps in the series to manufacture the object by, for each step:
providing actual values of attributes achieved by preceding steps in the series to a respective machine learning model, from a plurality of machine learning models, to determine a respective target value for a respective attribute to be achieved by the respective step;
performing the respective step to achieve the respective target value of the respective attribute; and
after performing the respective step, measuring a respective actual value of the respective attribute achieved by the respective step.

29. The system of claim 28, wherein each step in the series of steps has a respective manufacturing tolerance.

30. The system of claim 28, wherein the at least one non-transitory storage device comprises computer-executable program code that, when executed by the at least one processing device, causes the at least one processing device to train the plurality of machine learning models using historical data comprising (i) historical actual values measured after historical performance of each step of the steps to manufacture historical objects and (ii) historical test results obtained by testing the historical objects.

31. The system of claim 28, comprising one or more devices for manufacturing objects, wherein the at least one non-transitory storage device comprises computer-executable program code that, when executed by the at least one processing device, causes the at least one processing device to, when performing the initial step and the subsequent steps in the series, perform the initial step and the subsequent steps in the series using the one or more devices for manufacturing objects.

32. The system of claim 28, comprising one or more devices for measuring attributes, wherein the at least one non-transitory storage device comprises computer-executable program code that, when executed by the at least one processing device, causes the at least one processing device to:
when measuring the actual value of the attribute achieved by the initial step, measure the actual value using the one or more devices for measuring attributes; and
when measuring the respective actual value of the respective attribute achieved by the respective step of the subsequent steps, measure the respective actual value using the one or more devices for measuring attributes.

33. The system of claim 28, comprising one or more devices for testing objects to obtain test results, wherein the at least one non-transitory storage device comprises computer-executable program code that, when executed by the at least one processing device, causes the at least one processing device to, after performing the series of steps:
perform one or more tests on the object to obtain test results; and
retrain the plurality of machine learning models using data comprising actual values measured after performance of each step of the series of steps and the test results.
